(19) United States
(12) Patent Application Publication
(10) Pub. No.: US 2018/0326392 A1
(43) Pub. Date: Nov. 15, 2018

(54) DEVICE FOR PRODUCING POLY(METH)ACRYLATE IN POWDER FORM

(71) Applicant: BASF SE, Ludwigshafen am Rhein (DE)

(72) Inventors: Marco Krüger, Mannheim (DE); Karl Possemiers, 'S Gravenwezel (BE); Rudolf Schliwa, Alzenau (DE); Robert Bayer, Sinsheim (DE)

(21) Appl. No.: 15/774,620

(22) PCT Filed: Nov. 16, 2016
(86) PCT No.: PCT/EP2016/077806

§ 371 Date: May 9, 2018

(30) Foreign Application Priority Data
Nov. 17, 2015 (EP) 15194979.9

(51) Int. Cl. B01J 19/24; B01J 19/06; B01J 8/18; B01J 8/22; B01J 8/00; C08F 120/14

(52) U.S. Cl. CPC B01J 19/245; B01J 19/06; B01J 8/1818; B01J 2219/185; B01J 8/0055; C08F 120/14; B01J 2208/00761; B01J 8/22

(57) ABSTRACT

The invention relates to an apparatus for producing pulverulent poly(meth)acrylate, comprising a reactor for droplet polymerization having an apparatus for dropletization of a monomer solution for the preparation of the poly(meth)acrylate having holes through which the monomer solution is introduced, an addition point for a gas above the apparatus for dropletization, at least one gas withdrawal point on the circumference of the reactor and a fluidized bed, the reactor comprising a reactor shell between the apparatus for dropletization and the gas withdrawal point and having, above the fluidized bed, a region having decreasing hydraulic diameter toward the fluidized bed and having a maximum hydraulic diameter greater than the mean hydraulic diameter of the reactor shell, and the reactor shell projecting into the region having decreasing hydraulic diameter, so as to form an annular duct between the outer wall of the reactor shell and the wall by which the region having decreasing hydraulic diameter is bounded, and the at least one gas withdrawal point being disposed in the annular duct, wherein the ratio of the horizontal area of the annular duct to the horizontal area enclosed by the reactor shell is in the range from 0.3 to 5.

The invention proceeds from an apparatus for producing pulverulent poly(meth)acrylate, comprising a reactor for droplet polymerization having an apparatus for dropletization of a monomer solution for the preparation of the poly(meth)acrylate having holes through which the monomer solution is introduced, an addition point for a gas above the apparatus for dropletization, at least one gas withdrawal point on the circumference of the reactor and a fluidized bed, the reactor comprising a reactor shell between the apparatus for dropletization and the gas withdrawal point and having, above the fluidized bed, in the direction of the gas withdrawal point, a region having decreasing hydraulic diameter and having a maximum hydraulic diameter greater than the mean hydraulic diameter of the reactor shell, and the reactor shell projecting into the region having decreasing hydraulic diameter, so as to form an annular duct between the outer wall of the reactor shell and the wall by which the region having decreasing hydraulic diameter is bounded, and the at least one gas withdrawal point being disposed in the annular duct.

Poly(meth)acrylates find use especially as water-absorbing polymers which are used, for example, in the production of diapers, tampons, sanitary napkins and other hygiene articles, or else as water-retaining agents in market gardening.

The properties of the water-absorbing polymers can be adjusted via the level of crosslinking. With increasing level of crosslinking, there is a rise in gel strength and a fall in absorption capacity. This means that centrifuge retention capacity decreases with rising absorption under pressure, and the absorption under pressure also decreases again at very high levels of crosslinking.

To improve the performance properties, for example liquid conductivity in the diaper and absorption under pressure, water-absorbing polymer particles are generally postcrosslinked. This only increases the level of crosslinking at the particle surface, and in this way it is possible to at least partly decouple absorption under pressure and centrifuge retention capacity. This postcrosslinking can be performed in aqueous gel phase. In general, however, ground and sieved polymer particles are surface coated with a postcrosslinker, thermally postcrosslinked and dried. Crosslinkers suitable for this purpose are compounds which comprise at least two groups which can form covalent bonds with the carboxylate groups of the hydrophilic polymer.

Different processes are known for production of the water-absorbing polymer particles. For example, the monomers and any additives used for production of poly(meth)acrylates can be added to a mixing kneader, in which the monomers react to give the polymer. Rotating shafts with kneading bars in the mixing kneader break up the polymer formed into chunks. The polymer withdrawn from the kneader is dried and ground and sent to further processing. In an alternative variant, the monomer is introduced in the form of a monomer solution which may also comprise further additives into a reactor for droplet polymerization. On introduction of the monomer solution into the reactor, it disintegrates into droplets. The mechanism of droplet formation may be turbulent or laminar jet disintegration, or else dropletization. The mechanism of droplet formation depends on the entry conditions and the physical properties of the monomer solution. The droplets fall downward in the reactor, in the course of which the monomer reacts to give the polymer. In the lower region of the reactor is a fluidized bed into which the polymer particles formed from the droplets by the reaction fall. Further reaction then takes place in the fluidized bed. Corresponding processes are described, for example, in WO-A 2006/079631, WO-A 2008/086976, WO-A 2007/031441, WO-A 2008/040715, WO-A 2010/003855 and WO-A 2011/026876.

In the reactors for droplet polymerization described, gas is added at two points. A first gas stream is introduced above the apparatus for dropletization and a second gas stream from below through the fluidized bed. These gas streams have opposing flow directions. The gas is drawn off from the reactor via the annular duct which is formed by the reactor shell which projects into the region with decreasing hydraulic diameter. In this case, the entire gas volume supplied to the reactor has to be conducted away. This leads to high gas velocities in the region of the annular duct, and the gas velocities can be so high that polymer material is entrained with the gas through the annular duct. This leads firstly to a reduction in the yield or to elevated load on the offgas dedusting; secondly, there is a risk that the entrained particles can stick to walls of the annular duct and the downstream gas-conducting lines as a result of as yet incompletely reacted monomer solution and thus lead to unwanted deposits.

It is therefore an object of the present invention to produce a reactor for droplet polymerization for the production of pulverulent poly(meth)acrylate, in which droplet or particle entrainment in the region of the annular duct is avoided.

This object is achieved by an apparatus for producing pulverulent poly(meth)acrylate, comprising a reactor for droplet polymerization having an apparatus for dropletization of a monomer solution for the preparation of the poly(meth)acrylate having holes through which the monomer solution is introduced, an addition point for a gas above the apparatus for dropletization, at least one gas withdrawal point on the circumference of the reactor and a fluidized bed, the reactor comprising a reactor shell between the apparatus for dropletization and the gas withdrawal point and having, above the fluidized bed, a region having decreasing hydraulic diameter toward the gas withdrawal point and having a maximum hydraulic diameter greater than the mean hydraulic diameter of the reactor shell, and the reactor shell projecting into the region having decreasing hydraulic diameter, so as to form an annular duct between the outer wall of the reactor shell and the wall by which the region having decreasing hydraulic diameter is bounded, and the at least one gas withdrawal point being disposed in the annular duct, wherein the ratio of the horizontal area of the annular duct to the horizontal area enclosed by the reactor shell is in the range from 0.3 to 5.

The annular duct may either be in one-piece or segmented form. In the case of a one-piece annular duct, it runs in a ring around the reactor shell without interruption. Alternatively, a one-piece annular duct may also contain a dividing wall, in which case the latter runs in radial direction between the reactor shell and the wall of the region having decreasing hydraulic diameter. A segmented annular duct is divided into individual regions by a plurality of, i.e. at least two, corresponding radial dividing walls. In the case of a segmented annular duct, each segment of the annular duct is connected to at least one gas withdrawal point, and it is also possible for a plurality of gas withdrawal points to be present in one segment according to the size of the segment. As well as segmentation by radial dividing walls, another possibility is segmentation by a dividing wall that runs round the reactor shell at a constant distance. However, the standard method of segmentation is by radial dividing walls. The segmentations may in principle also be partly interrupted or may be executed only in the edge regions of the annular duct, for example, in the form of internal reinforcing fins. It is more preferable, however, when the annular duct in the reactor interior is not segmented.

For static stabilization of the reactor, it is additionally possible that support struts run within the annular duct between the reactor shell and the wall of the region having decreasing hydraulic diameter which forms the outer edge of the annular duct. Both in the case of segmented configuration of the annular duct and in the case of support struts provided within the annular duct, it is generally possible to neglect the area occupied by the struts or the walls for the determination of the cross-sectional area of the annular duct. The area occupied by the walls should only be taken into account when the annular duct has been divided into very many small segments or when segmentation has been accomplished using very thick dividing walls or even displacer regions having an effective displacement of more than 5% of the annular duct area running at right angles to the reactor axis.

The configuration of the reactor for droplet polymerization in such a way that the ratio of the horizontal area of the annular duct to the horizontal area enclosed by the reactor shell is in the range from 0.3 to 5 achieves the effect that the amount of the particles entrained into the annular duct with the gas stream is minimized and only very small dust particles are entrained. These dust particles generally do not form any caking either, since the particles are so small that the total amount of monomer present therein has been converted to the polymer and the water has been evaporated. As a result of the inventive configuration of the annular duct, under standard operating conditions of the reactor for droplet polymerization, a gas velocity in the annular duct of 0.25 to 3 m/s, preferably 0.5 to 2.5 m/s and especially 1.0 to 1.8 m/s is established.

In a preferred embodiment, the ratio of the horizontal area of the annular duct to the horizontal area enclosed by the reactor shell is in the range from 0.4 to 3.5 and especially in the range from 0.5 to 2.

A reactor for droplet polymerization generally comprises a head with an apparatus for dropletization of a monomer solution, a middle region through which the dropletized monomer solution falls and is converted into polymer, and a fluidized bed into which the polymer droplets fall. The fluidized bed concludes the region of the reactor with decreasing hydraulic diameter at the lower end.

In order that the monomer solution exiting the apparatus for dropletization is not sprayed onto the wall of the reactor, and in order at the same time to configure the reactor advantageously both in terms of statics and in terms of material costs, it is preferable to form the head of the reactor in the shape of a frustocone and to position the apparatus for dropletization in the frustoconical head of the reactor.

The frustoconical configuration of the head of the reactor makes it possible to economize on materials compared to a cylindrical configuration. Moreover, a frustoconical head improves the structural stability of the reactor. A further advantage is that the gas which is introduced at the head of the reactor has to be supplied through a relatively small cross section and subsequently, due to the frustoconical configuration, flows downward in the reactor without significant vortexing. The vortexing that may occur in the case of a cylindrical configuration of the reactor in the head region and a gas feed in the middle of the reactor has the disadvantage that droplets that are entrained with the gas flow may be transported against the wall of the reactor because of the vortexing and hence may contribute to fouling.

In order to keep the height of the reactor as low as possible, it is further advantageous when the apparatus for dropletization of the monomer solution is disposed as far upward as possible in the frustoconically configured head. This means that the apparatus for dropletization of the monomer solution is disposed at the height in the frustoconically configured head at which the diameter of the frustoconically configured head is roughly the same as the diameter of the apparatus for dropletization.

In order to prevent the monomer solution which exits the apparatus for dropletization in the region of the outermost holes from being sprayed against the wall of the frustoconically configured head, it is particularly preferable when the hydraulic diameter of the frustoconically configured head, at the height at which the apparatus for dropletization is disposed, is 2% to 30%, more preferably 4% to 25%, and more particularly 5% to 20%, greater than the hydraulic diameter of the area enclosed by the shortest line connecting the outermost holes. The somewhat greater hydraulic diameter of the head additionally ensures that droplets, even below the reactor head, do not prematurely hit the reactor wall and adhere thereto.

Above the apparatus for dropletization of the monomer solution there is an addition point for gas, and gas and droplets therefore flow cocurrently through the reactor from top to bottom. Since the fluidized bed is in the lower region of the reactor, the effect of this is that gas flows in the opposite direction from the bottom upward in the lower region of the reactor. Since gas is introduced into the reactor both from the top and from the bottom, the gas needs to be withdrawn between the apparatus for dropletization of the monomer solution and the fluidized bed. According to the invention, the gas withdrawal point is positioned at the transition from the reactor shell to the region having decreasing hydraulic diameter in the direction of the fluidized bed.

In the region with decreasing hydraulic diameter, the hydraulic diameter decreases from the top downward from the gas withdrawal point in the direction of the fluidized bed. The decrease in the hydraulic diameter is preferably linear, such that the region having decreasing hydraulic diameter takes the form of an upturned frustocone.

The hydraulic diameter dₕ, is defined as:

dₕ=4·A/C

where A is area and C is circumference. Using the hydraulic diameter renders the configuration of the reactor independent of the shape of the cross-sectional area. This area may, for example, be circular, rectangular, in the shape of any polygon, oval or elliptical. However, preference is given to a circular cross-sectional area. In the context of the present invention, the mean hydraulic diameter is understood to mean the arithmetic mean.

The reactor shell which extends between the head having the apparatus for dropletization and the gas withdrawal point preferably has a constant hydraulic diameter. More preferably, the reactor shell is cylindrical. Alternatively, it is also possible to configure the reactor shell such that the hydraulic diameter thereof increases from the top downward. In this case, however, it is preferable that the hydraulic diameter at the lower end of the reactor shell is not more than 10%, preferably not more than 5% and especially not more than 2% greater than the hydraulic diameter at the transition from the reactor head to the reactor shell. More preferably, however, the reactor shell is executed with a constant hydraulic diameter and the reactor shell is more preferably cylindrical.

The height of the annular duct is preferably configured such that the ratio of the distance between the outer wall of the reactor shell and the wall of the region having decreasing hydraulic diameter at the inlet into the annular duct and the height of the annular duct between the inlet into the annular duct and the lower edge of the gas withdrawal point is in the range from 0.05 to 50. Preferably, the ratio of the distance between the outer wall of the reactor shell and the wall of the region having decreasing hydraulic diameter at the inlet into the annular duct and the height of the annular duct between the inlet into the annular duct and the lower edge of the gas withdrawal point is in the range from 0.2 to 25 and especially in the range from 0.5 to 10.

An appropriate ratio of the distance between the outer wall of the reactor shell and the wall of the region having decreasing hydraulic diameter at the inlet into the annular duct and the height of the annular duct between the inlet into the annular duct and the lower edge of the gas withdrawal point achieves a sufficiently large volume of the annular duct in the form of a calming and settling zone in order to prevent the significant increase in velocity which occurs as a result of the standard cross-sectional constriction in the region of the gas withdrawal points, generally an increase in the velocity by at least a factor of 3, from leading to increased particle entrainment out of the reactor.

The inlet into the annular duct is understood in the context of the present invention to mean the area formed at right angles to the axis of the reactor between the lower end of the reactor shell and the wall of the region having decreasing hydraulic diameter.

The at least one gas withdrawal point is generally positioned either at the outer circumferential face of the annular duct or alternatively and preferably at the wall that concludes the annular duct in the upward direction. In this case, the wall that concludes the annular duct in the upward direction is preferably at an angle in the range from 45 to 90° to the reactor axis. Alternatively, it is also possible to execute the wall that concludes the annular duct in the upward direction with a curved section, preferably a section which is parabolic, elliptical or in the form of a quarter circle. When the wall that concludes the annular duct in the upward direction has a curved section, the latter is aligned such that the curvature runs concave within the annular duct.

In order, if necessary, to separate out particles entrained with the gas stream after all, in one embodiment of the invention, every gas withdrawal point is connected to an apparatus for removal of solids. This means that the number of apparatuses for removal of solids is the same as the number of gas withdrawal points. Alternatively, however, it is also possible to connect each of at least two gas withdrawal points to one apparatus for removal of solids. In this case, the apparatus for removal of solids has to be sufficiently large that the combined gas streams from the at least two gas withdrawal points can be conducted through the apparatus for removal of solids. Preference is given, however, to the embodiment in which every gas withdrawal point is connected to an apparatus for removal of solids.

Suitable apparatuses for removal of solids are, for example, filters or centrifugal separators, for example cyclones. Particular preference is given to cyclones. In order to enable inspection or cleaning of the apparatus for removal of solids without interrupting the operation of the reactor for droplet polymerization, it is possible to provide redundant systems in which two apparatuses for removal of solids are provided in parallel in each case, and the gas stream is always conducted through one apparatus for removal of solids, while the other is switched off and can be cleaned, for example. This is advisable especially in the case of use of filters.

In order to keep the cross-sectional area of the gas withdrawal points and hence also the gas flow flowing through one gas withdrawal point to a manageable size, and to assure a symmetric arrangement of the gas withdrawal points for an undisrupted flow profile in the reactor, it is preferable when at least two gas withdrawal points are provided and the gas withdrawal points are arranged uniformly over the circumference of the annular duct. The number of gas withdrawal points is calculated from the gas volumes that flow through the reactor and the cross-sectional area of the gas withdrawal points. It is particularly preferable when at least three gas withdrawal points are provided, and especially at least four gas withdrawal points. “Arranged uniformly over the circumference of the annular duct” means that the distance between the centers of two adjacent gas withdrawal points is the same in each case for all the gas withdrawal points.

For undisrupted operation of the reactor for droplet polymerization, it has been found that a ratio of the horizontal cross-sectional area of the annular duct to the total cross-sectional area of all gas withdrawal points in the range from 1.5 to 150 is advantageous. Preferably, the ratio of the horizontal cross-sectional area of the annular duct to the total cross-sectional area of all gas withdrawal points is in the range from 3 to 90 and especially in the range from 6 to 30. The horizontal cross-sectional area of the annular duct is the area formed at right angles to the reactor axis between the reactor shell and the wall of the region having decreasing hydraulic diameter. The total cross-sectional area of all gas withdrawal points is the sum total of the cross-sectional areas of the gas withdrawal points, the cross-sectional areas of the gas withdrawal points being the cross-sectional area transverse to the flow direction of the gas and hence at right angles to the center axis through the gas withdrawal point.

In one embodiment of the invention, the lower end of the reactor shell has a region having an increase in diameter, the region having the increase in diameter being completely within the region which forms the annular duct. The increase in diameter in the region of the lower end of the reactor shell can reduce the formation of deposits resulting from adhering polymer particles. The increase in diameter at the lower end of the reactor shell is preferably conical and has an opening angle in the range from 0 to 10°.

The region having decreasing hydraulic diameter may have a decreasing hydraulic diameter over the entire height. In this case, the distance between the outer wall of the annular duct formed by the region having decreasing hydraulic diameter and the inner wall of the annular duct formed by the reactor shell increases from the bottom upward, such that the cross-sectional area of the annular duct becomes greater from the bottom upward. It is preferable, however, when the top of the region having decreasing hydraulic diameter is connected to a region having constant hydraulic diameter such that the outer wall of the annular duct has a constant hydraulic diameter. In the case of a reactor shell having a constant hydraulic diameter, this means that the cross-sectional area in the annular duct beneath the transition to the wall that concludes the annular duct in the upward direction remains constant.

Embodiments of the invention are shown in the figures and are more particularly described in the description which follows.

The figures show:

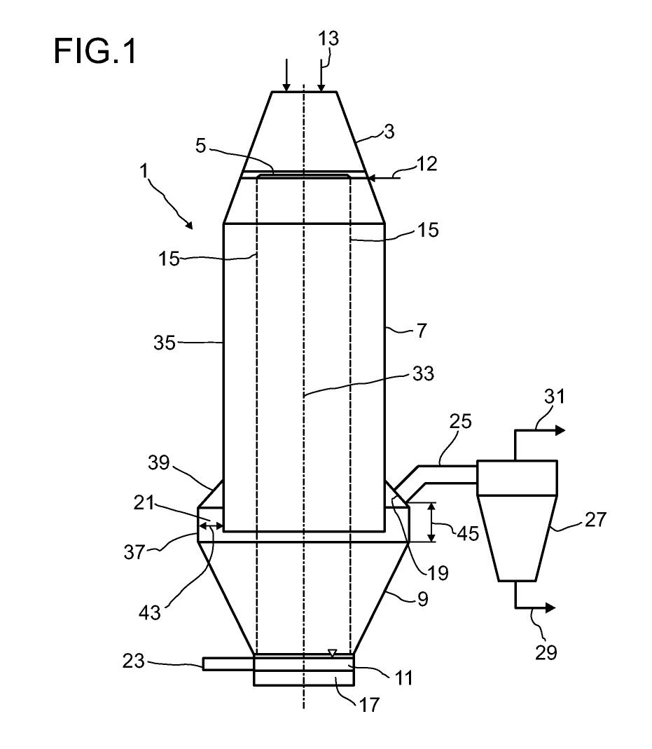

FIG. 1 a longitudinal section through a reactor for droplet polymerization,

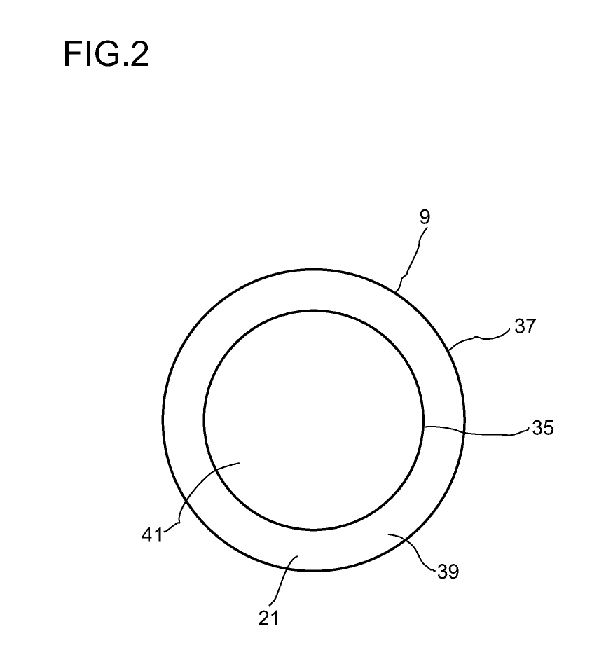

FIG. 2 a cross section through the reactor for droplet polymerization in the region of the annular duct

FIG. 1 shows a longitudinal section through a reactor configured according to the invention.

A reactor 1 for droplet polymerization comprises a reactor head 3 which accommodates an apparatus for dropletization 5, a middle region 7 in which the polymerization reaction proceeds, and a lower region 9 having a fluidized bed 11 in which the reaction is concluded.

For performance of the polymerization reaction to prepare the poly(meth)acrylate, the apparatus for dropletization 5 is supplied with a monomer solution via a monomer feed 12. When the apparatus for dropletization 5 has a plurality of channels, it is preferable to supply each channel with the monomer solution via a dedicated monomer feed 12. The monomer solution exits through holes, which are not shown in FIG. 1, in the apparatus for dropletization 5 and disintegrates into individual droplets which fall downward within the reactor. Through a first addition site for a gas 13 above the apparatus for dropletization 5, a gas, for example nitrogen or air, is introduced into the reactor 1. This gas flow supports the disintegration of the monomer solution exiting from the holes of the apparatus for dropletization 5 into individual droplets. In addition, the way in which the addition point for gas 13 is designed promotes lack of contact of the individual droplets and coalescence thereof to larger droplets.

In order firstly to make the cylindrical middle region 7 of the reactor very short and additionally to avoid droplets hitting the wall of the reactor 1, the reactor head 3 is preferably conical, as shown here, in which case the apparatus for dropletization 5 is within the conical reactor head 3 above the cylindrical region. Alternatively, however, it is also possible to make the reactor cylindrical in the reactor head 3 as well, with a diameter as in the middle region 7. Preference is given, however, to a conical configuration of the reactor head 3. The position of the apparatus for dropletization 5 is selected such that there is still a sufficiently large distance between the outermost holes through which the monomer solution is supplied and the wall of the reactor to prevent the droplets from hitting the wall. For this purpose, the distance should at least be in the range from 50 to 1500 mm, preferably in the range from 100 to 1250 mm and especially in the range from 200 to 750 mm. It will be appreciated that a greater distance from the wall of the reactor is also possible. This has the disadvantage, however, that a greater distance is associated with poorer exploitation of the reactor cross section.

The lower region 9 concludes with a fluidized bed 11, into which the polymer particles formed from the monomer droplets fall during the fall. In the fluidized bed, further reaction proceeds to give the desired product. According to the invention, the outermost holes through which the monomer solution is dropletized are positioned such that a droplet falling vertically downward falls into the fluidized bed 11. This can be achieved, for example, by virtue of the hydraulic diameter of the fluidized bed being at least as large as the hydraulic diameter of the area which is enclosed by a line connecting the outermost holes in the apparatus for dropletization 5, the cross-sectional area of the fluidized bed and the area formed by the line connecting the outermost holes having the same shape and the centers of the two areas being at the same position in a vertical projection of one onto the other. The outermost position of the outer holes relative to the position of the fluidized bed 11 is shown in FIG. 1 with the aid of a dotted line 15.

In order, in addition, to avoid droplets hitting the wall of the reactor in the middle region 7 as well, the hydraulic diameter at the level of the midpoint between the apparatus for dropletization and the gas withdrawal point is at least 10% greater than the hydraulic diameter of the fluidized bed.

The reactor 1 may have any desired cross-sectional shape. However, the cross section of the reactor 1 is preferably circular. In this case, the hydraulic diameter corresponds to the diameter of the reactor 1.

Above the fluidized bed 11, the diameter of the reactor 1 increases in the embodiment shown here, such that the reactor 1 widens conically from the bottom upward in the lower region 9.

This has the advantage that polymer particles formed in the reactor 1 that hit the wall can slide downward into the fluidized bed 11 along the wall. To avoid caking, it is additionally possible to provide tappers, not shown here, on the outside of the conical part of the reactor, with which the wall of the reactor is set in vibration, as a result of which adhering polymer particles are detached and slide into the fluidized bed 11.

For gas supply for the operation of the fluidized bed 11, a gas distributor 17 present beneath the fluidized bed 11 blows the gas into the fluidized bed 11.

Since gas is introduced into the reactor 1 both from the top and from the bottom, it is necessary to withdraw gas from the reactor 1 at a suitable position. For this purpose, at least one gas withdrawal point 19 is disposed at the transition from the middle region 7 having constant cross section to the lower region 9 which widens conically from the bottom upward. In this case, the wall of the cylindrical middle region 7 projects into the lower region 9 which widens conically in the upward direction, the diameter of the conical lower region 9 at this position being greater than the diameter of the middle region 7. In this way, an annular duct 21 which surrounds the wall of the middle region 7 is formed, into which the gas flows and can be drawn off through the at least one gas withdrawal point 19 connected to the annular duct 21.

The further-reacted polymer particles of the fluidized bed 11 are withdrawn via at least one product withdrawal point 23 in the region of the fluidized bed.

In order to remove any particles entrained by the gas withdrawal point 19 from the gas stream, the gas withdrawal point 19 is connected via a gas duct 25 to at least one apparatus for solids removal 27, for example a filter or a cyclone, preferably a cyclone. From the cyclone, it is then possible for the solid particles separated from the gas to be withdrawn via a solids withdrawal, and the gas which has been freed of solids via a gas takeoff 31.

For homogeneous gas withdrawal from the annular duct 24, it is preferable when several gas withdrawal points 19 are provided in homogeneous distribution over the circumference of the annular duct 21. In this case, it is possible that each gas withdrawal point 19 is connected to an apparatus for solids removal 27 or, alternatively, that each of several gas withdrawal points 19 are passed into an apparatus for solids removal 27. Preference is given, however, to such a configuration that every gas withdrawal point 19 is connected to a separate apparatus for solids removal 27.

In a preferred embodiment of the invention, the ratio of the distance 43 between the outer wall of the reactor shell 35 and the wall of the lower region 9 having decreasing hydraulic diameter at the inlet into the annular duct 21 and the height 45 of the annular duct 21 between the inlet into the annular duct 21 and the lower edge of the gas withdrawal point 19 is in the range from 0.05 to 50.

FIG. 2 shows a cross section of the reactor in the region of the annular duct.

The reactor 1 preferably has a circular cross section, such that it is symmetric with respect to a reactor axis 33 which runs vertically from the top downward and is shown in FIG. 1.

The middle region 7 preferably has, as shown in FIG. 1, a constant hydraulic diameter, such that the reactor shell 35 which encloses the middle region 7 has a cylindrical shape in the case of a cylindrical cross section.

The lower region 9 has a decreasing hydraulic diameter, such that the hydraulic diameter is at its smallest in the region immediately above the fluidized bed and at its greatest at the upper end of the lower region 9 with the decreasing hydraulic diameter. In the embodiment shown in FIG. 1, the lower region 9 having decreasing hydraulic diameter is connected at the top to a region having constant diameter 37, such that the outer wall of the annular duct 21 formed by the lower region 9 runs parallel to the reactor axis and the annular duct thus has a constant cross-sectional area 39 beneath the wall 39 that concludes the annular duct in the upward direction. According to the invention, the ratio of the cross-sectional area 39 of the annual duct 21, corresponding to the horizontal area of the annular duct 21, to the area 41 enclosed by the reactor shell 35 is in the range from 0.3 to 5.

### LIST OF REFERENCE NUMERALS

1 reactor
3 reactor head
5 apparatus for dropletization
7 middle region
9 lower region
11 fluidized bed
12 monomer feed
13 addition point for gas
15 position of the outermost holes in relation to the fluidized bed 11
17 gas distributor
19 gas withdrawal point
21 annular duct
23 product withdrawal point
25 gas duct
27 apparatus for solids removal
29 solids withdrawal
31 gas takeoff
33 reactor axis
35 reactor shell
37 region having constant diameter
39 cross-sectional area of the annular duct 21
41 area enclosed by the reactor shell 35
43 distance between the outer wall of the reactor shell 35 and the wall of the lower region 9
45 height of the annular duct 21 between the inlet into the annular duct 21 and the lower edge of the gas withdrawal point 19

1.-10. (canceled)

11. An apparatus for producing pulverulent poly(meth)acrylate, comprising a reactor (1) for droplet polymerization having an apparatus (5) for dropletization of a monomer solution for the preparation of the poly(meth)acrylate having holes through which the monomer solution is introduced, an addition point (13) for a gas above the apparatus (5) for dropletization, at least one gas withdrawal point (19) on the circumference of the reactor (1) and a fluidized bed (11), the reactor (1) comprising a reactor shell (35) between the apparatus for dropletization (5) and the gas withdrawal point (19) and having, above the fluidized bed (11), a region (9) having decreasing hydraulic diameter toward the fluidized bed and having a maximum hydraulic diameter greater than the mean hydraulic diameter of the reactor shell (35), and the reactor shell (35) projecting into the region (9) having decreasing hydraulic diameter, so as to form an annular duct (21) between the outer wall of the reactor shell (35) and the wall by which the region (9) having decreasing hydraulic diameter is bounded, and the at least one gas withdrawal point (19) being disposed in the annular duct (21), wherein the ratio of the horizontal area (39) of the annular duct (21) to the horizontal area (41) enclosed by the reactor shell (35) is in the range from 0.3 to 5.

12. The apparatus according to claim 11, wherein the ratio of the distance (43) between the outer wall of the reactor shell (35) and the wall of the region (9) having decreasing hydraulic diameter at the inlet into the annular duct (21) and the height (45) of the annular duct (21) between the inlet into the annular duct (21) and the lower edge of the gas withdrawal point (19) is in the range from 0.05 to 50.

13. The apparatus according to claim 11, wherein each gas withdrawal point (19) is connected to an apparatus for removal of solids (27).

14. The apparatus according to claim 13, wherein the apparatus for removal of solids (27) is a cyclone.

15. The apparatus according to claim 11, wherein at least two gas withdrawal points (19) are connected to one apparatus for removal of solids (27).

16. The apparatus according to claim 15, wherein the apparatus for removal of solids (27) is a cyclone.

17. The apparatus according to claim 11, wherein at least two gas withdrawal points (19) are provided and the gas withdrawal points (19) are arranged uniformly over the circumference of the annular duct (21).

18. The apparatus according to claim 11, wherein the ratio of the horizontal cross-sectional area (39) of the annular duct (21) to the total cross-sectional area of all gas withdrawal points (19) is in the range from 1.5 to 150.

19. The apparatus according to claim 11, wherein the lower end of the reactor shell (35) has a region having an increase in diameter, the region having the increase in diameter being completely within the region which forms the annular duct (21).

20. The apparatus according to claim 19, wherein the increase in diameter at the lower end of the reactor shell (35) is conical and has an opening angle in the range from 0 to 10°.

21. The apparatus according to claim 11, wherein the top of the region (9) having decreasing hydraulic diameter is connected to a region having constant hydraulic diameter (37) such that the outer wall of the annular duct (21) has a constant hydraulic diameter.
